(19) United States
(12) Patent Application Publication
(10) Pub. No.: US 2005/0169308 A1
(43) Pub. Date: Aug. 4, 2005

(54) Communication device and communication method

(75) Inventors: Ryutaro Hashi, Kanazawa-shi (JP); Atsushi Sumasu, Yokosuka-shi (JP)

Correspondence Address: STEVENS DAVIS MILLER & MOSHER, LLP, 1615 L STREET, NW, SUITE 850, WASHINGTON, DC, 20036, US

(73) Assignee: Matsushita Electric Industrial Co., LTD., Osaka (JP)

(21) Appl. No.: 10/511,091

(22) PCT Filed: Jul. 30, 2003
(86) PCT No.: PCT/JP03/09626

(30) Foreign Application Priority Data
Oct. 15, 2002 (JP) 2002-300726

(51) Int. Cl. H04L 12/54

(52) U.S. Cl. 370/469; 370/428

(57) ABSTRACT

A communication apparatus and a communication method are provided which offer an enhanced average transmission rate while preventing deterioration of the accuracy of information communication. A transmitting section (100) sends information data and link establish data to a receiving side apparatus not shown. An information data generating section (110) generates information data such as speech data. A link establish data generating section (120) generates link establish data for establishing a link with the receiving side apparatus not shown prior to the transmission of information data. After reception of a receiving response about link establish data, a control section (130) causes the information data generating section (110) to generate information data to be sent over the established link and the transmitting section (100) sends it. When further establishment of a link is needed, the control section (130) causes, before the reception of a receiving response about the preceding information data, the link establish data generating section (120) to generate link establish data for the next information data and the transmitting section (100) sends it.

### TECHNICAL FIELD

The present invention relates to a communication apparatus and a communication method.

### BACKGROUND ART

In data communications, in general, communication protocol are defined as rules for the exchange of information between communicating terminals and computers. For example, communication protocol pertaining to the transmission of information in data communication systems include the Basic Mode Data Transmission Control Procedure (hereinafter “basic procedure”) and the HDLC (High-level Data Link Control) procedures based on the OSI (Open System Interconnection) protocol.

Some communication protocol require ensuring in advance a physical channel on which information is transmitted and a logical channel (hereinafter referred to as a link) defined by the protocols. Therefore, in order to ensure a link, a communication apparatus may request a receiving side apparatus to establish a link before the transmission of information, and the receiving side apparatus, while establishing a link, sends back to the communication apparatus an acknowledgment reporting the reception of the link establishing request. In the basic procedure, which is an example of such communication protocol that require the establishment of links, information is transmitted through the five phases including the connection of a physical channel, the establishment of a link, the transfer of information, the termination of the link, and the disconnection of the physical channel.

As for the communication protocol like the basic procedures, a technique is known for increasing the amount of information transmitted through the above-mentioned series of phases to enhance the efficiency of the information transmission (for example, refer to Japanese Patent Application Laid-Open No. 10-247942).

However, pre-communications, typically including the link establishment, are performed not to send actual information but to send other data prior to the transmission of the actual information; therefore, performing a pre-communication prior to each transmission of a certain traffic of information would cause the problem of reduced average transmission rate in applications that require real-time transmission of information, e.g. video phones. “Pre-communications” herein include, as well as that for establishing links, negotiation for specifying destination terminals, communication rates, transmission formats, and so on.

Transmitting a large amount of information after a single pre-communication reduces the ratio of the pre-communication time with respect to the information transmission time, resulting in an enhanced average transmission rate. However, in communications that undergo considerable variations of transmission environments, e.g. in radio communications, enlarging the pre-communication intervals makes it difficult to follow the environmental variations, resulting in deteriorated accuracy of the information communication.

### DISCLOSURE OF INVENTION

An object of the present invention is to enhance the average transmission rate while preventing deterioration of the accuracy of information communication.

The main subject of the invention is, in communication in which a link is established each time a certain amount of information is transmitted, to start a link establishing operation for the next information before a receiving response about the preceding transmission of a certain amount of information is sent back.

According to one aspect of the present invention, a communication apparatus for use in a communication system that requires establishment of a link to transmit information between a transmitting side and a receiving side comprises: a transmitting section that transmits information data that contains a predetermined amount of information; and a requesting section that, before termination of a link for information data transmitted currently, requests the establishment of a link for transmitting next information data.

According to another aspect of the present invention, a communication method for use in a communication system that requires establishment of a link to transmit information between a transmitting side and a receiving side comprises the steps of: transmitting information data that contains a predetermined amount of information; and before termination of a link for the transmitted information data, requesting establishment of a link for transmitting next information data.

### BRIEF DESCRIPTION OF DRAWINGS

FIG. 1 is a block diagram showing main components of the communication apparatus according to a first embodiment of the invention;

FIG. 2 is a sequence chart illustrating the operation of the communication apparatus of the first embodiment;

FIG. 3 is a block diagram showing main components of the communication apparatus according to a second embodiment of the invention; and

FIG. 4 is a sequence chart illustrating the operation of the communication apparatus of the second embodiment.

### BEST MODE FOR CARRYING OUT THE INVENTION

The embodiments of the present invention are now described in detail referring to the drawings.

### First Embodiment

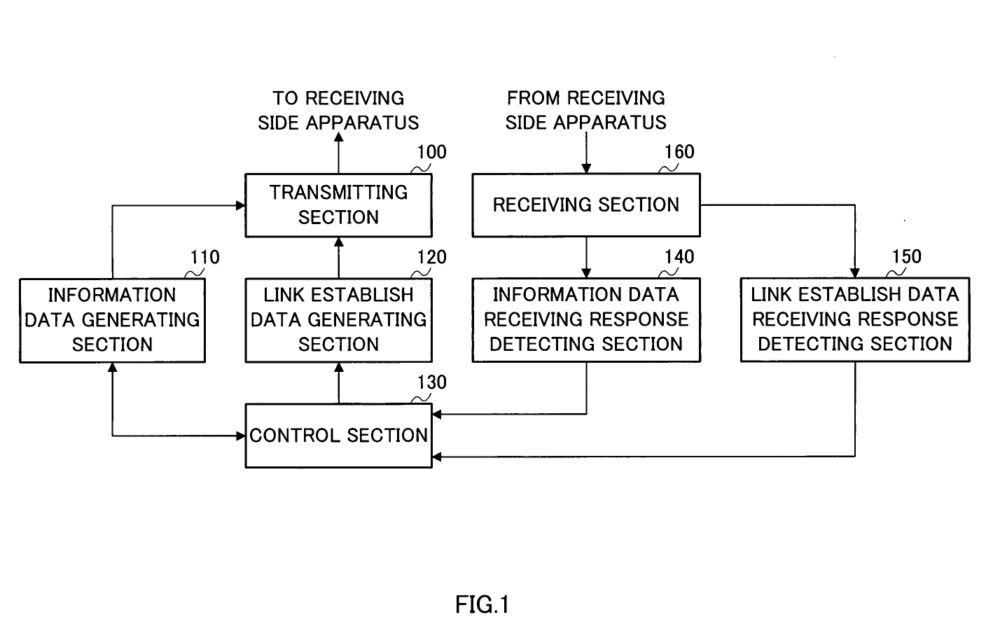

FIG. 1 is a block diagram showing main components of the communication apparatus of a first embodiment of the invention. The communication apparatus shown in FIG. 1 has a transmitting section 100, an information data generating section 110, a link establish data generating section 120, a control section 130, an information data receiving response detecting section 140, a link establish data receiving response detecting section 150, and a receiving section 160.

The transmitting section 100 transmits to a receiving side apparatus (not shown) information data generated by the information data generating section 110 and link establish data generated by the link establish data generating section 120.

The information data generating section 110 generates information data, such as speech data and image data.

The link establish data generating section 120 generates link establish data for requesting establishment of a link with the receiving side apparatus (not shown) prior to the transmission of information data.

The control section 130 controls the information data generating section 110 and the link establish data generating section 120 on the basis of the timing of transmission of information data, the timing of reception of information data receiving response, and the timing of reception of link establish data receiving response, whereby the information data and link establish data are generated and the timing of data transmission is controlled. More specifically, upon reception of a receiving response reporting the reception of link establish data, the control section 130 controls the information data generating section 110 to generate information data to be transmitted over the established link and causes the transmitting section 100 to transmit the information data. Then, after the transmission of the information data, and before the reception of a receiving response about that piece of information data, the control section 130 controls the link establish data generating section 120 to generate link establish data for the transmission of the next piece of information data, which is transmitted through the transmitting section 100. The timing of the data transmission and reception will be fully described later.

The information data receiving response detecting section 140 detects, from data received at the receiving section 160, a receiving response reporting the reception of information data.

The link establish data receiving response detecting section 150 detects, from data received at the receiving section 160, a receiving response about link establish data.

The receiving section 160 receives data transmitted from the receiving side apparatus (not shown), including receiving responses to information data and link establish data.

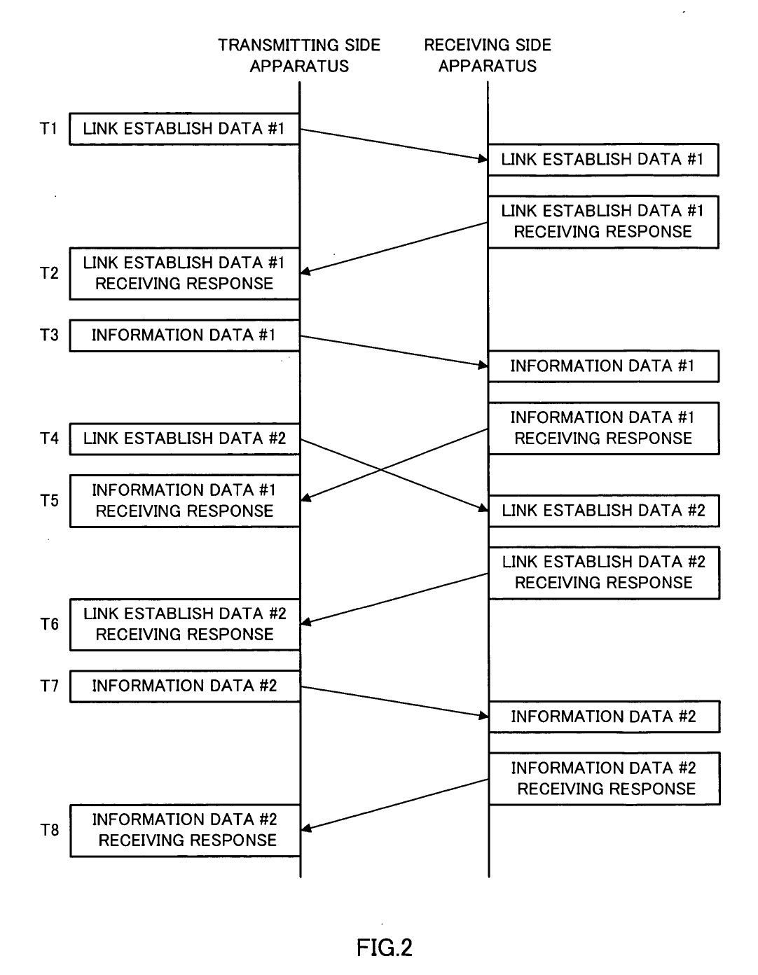

Next, the operation of the communication apparatus thus configured is specifically described referring to the sequence chart of FIG. 2.

First, when sending a certain amount of information data #1, the control section 130 controls the link establish data generating section 120 to generate link establish data #1 for requesting the establishment of a link for sending the information data #1, which is sent at time T1 by the transmitting section 100. When the receiving side apparatus receives the link establish data #1, a link for the transmission of the information data #1 with the communication apparatus of the embodiment is established and the receiving side apparatus sends a receiving response about the link establish data #1 to notify the communication apparatus of the reception of the link establish data #1.

Then, at time T2, the receiving section 160 receives the link establish data #1 receiving response and the link establish data receiving response detecting section 150 detects the reception of the link establish data #1 receiving response. When the link establish data receiving response detecting section 150 detects the reception of the link establish data #1 receiving response, the control section 130 is notified of it. Then the control section 130 detects that a link for sending the information data #1 has been established and controls the information data generating section 110 to generate the information data #1, which is sent at time T3 by the transmitting section 100.

When the information data #1 is sent by the transmitting section 100, the control section 130 is notified of it. The control section 130 then controls the link establish data generating section 120 to generate link establish data #2 for requesting the establishment of a link for sending the next information data #2, which is sent at time T4 by the transmitting section 100.

When the receiving side apparatus receives the information data #1 sent from the transmitting section 100, the receiving side apparatus sends a receiving response about the information data #1 to notify the communication apparatus of the reception of the information data #1. The receiving section 160 receives the information data #1 receiving response at time T5 and the information data receiving response detecting section 140 detects the reception of the information data #1 receiving response.

Now, it should be noted that the time T4 at which the link establish data #2 is sent is earlier than the time T5 at which the information data #1 receiving response is received, meaning that the communication apparatus begins the link establish operation for the next information data #2 before confirming that the information data #1 has been normally received at the receiving side apparatus. This is because establishing a link for sending the next information data #2 does not always require that the preceding information data #1 has been normally received at the receiving side apparatus.

This reduces the ratio of the time required only for the link establishment with respect to the total transmission time, without reducing the number of times that a link establish request is generated, thus making it possible to save transmission time resources.

Thus, in communications that suffer large propagation delay, where data transmission from a communication apparatus to a receiving side apparatus takes a long time, e.g. in satellite radio communications, data having a time length not more than the propagation delay, like that shown in FIG. 2, can be transferred by half duplex communication just by switching transmission and reception with proper timing.

Referring to FIG. 2 again, when the link establish data #2 sent at time T4 is received at the receiving side apparatus, a link for the transmission of the information data #2 is established with the communication apparatus of the embodiment, and the receiving side apparatus sends a link establish data #2 receiving response to notify the communication apparatus of the reception of the link establish data #2.

Then, at time T6, the receiving section 160 receives the link establish data #2 receiving response and the link establish data receiving response detecting section 150 detects the reception of the link establish data #2 receiving response. When the link establish data receiving response detecting section 150 detects the reception of the link establish data #2 receiving response, the control section 130 is notified of it. Then the control section 130 detects that a link for sending the information data #2 has been established, and it sends the information data #2 at time T7 and receives an information data #2 receiving response at time T8, as in the transmission of the information data #1. When next information data #3 (not shown) is to be sent, link establish data #3 (not shown) is sent between time T7 and time T8.

Thus, according to this embodiment, after a transmission of information data, the operation of establishing a link for the next information data is started without waiting for the reception of a receiving response about the preceding information data, which enhances the average transmission rate without reducing the number of times that a link is established and hence without deteriorating the accuracy of the information communication.

While this embodiment has shown a configuration in which the receiving side apparatus sends a receiving response to information data, no problem arises when it sends no receiving response to information data, as long as it sends a receiving response to link establish data.

### Second Embodiment

The feature of a second embodiment of the invention is that the current information data and the link establish data for requesting the establishment of a link for the next information data are multiplexed before being transmitted.

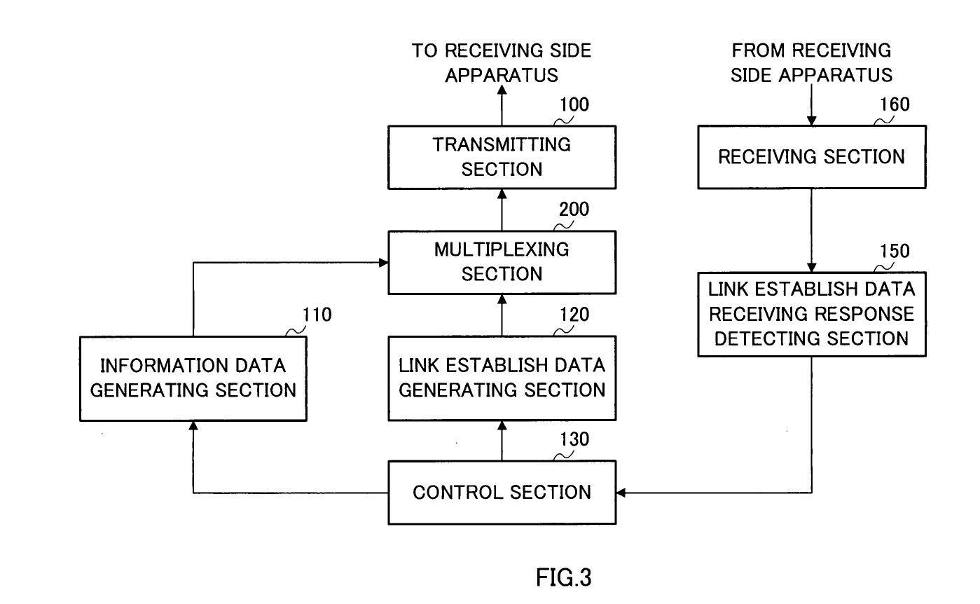

FIG. 3 is a block diagram showing the main components of the communication apparatus of this embodiment. In the communication apparatus of FIG. 3, the same components as those of the communication apparatus of FIG. 1 are shown at the same reference numerals and not described again here. The communication apparatus shown in FIG. 3 has a transmitting section 100, an information data generating section 110, a link establish data generating section 120, a control section 130, a link establish data receiving response detecting section 150, a receiving section 160, and a multiplexing section 200.

The multiplexing section 200 multiplexes information data generated by the information data generating section 110 and link establish data generated by the link establish data generating section 120. More specifically, the multiplexing section 200 multiplexes data by using, e.g. frequency division multiplexing where information data and link establish data are sent at different frequencies, code division multiplexing where link establish data is multiplied by a given spread code, or time division multiplexing where a given bit string is used as the link establish data, so that the receiving side apparatus can separate the link establish data from the information data. Note that the multiplexing section 200 multiplexes the current information data and the link establish data for the next information data.

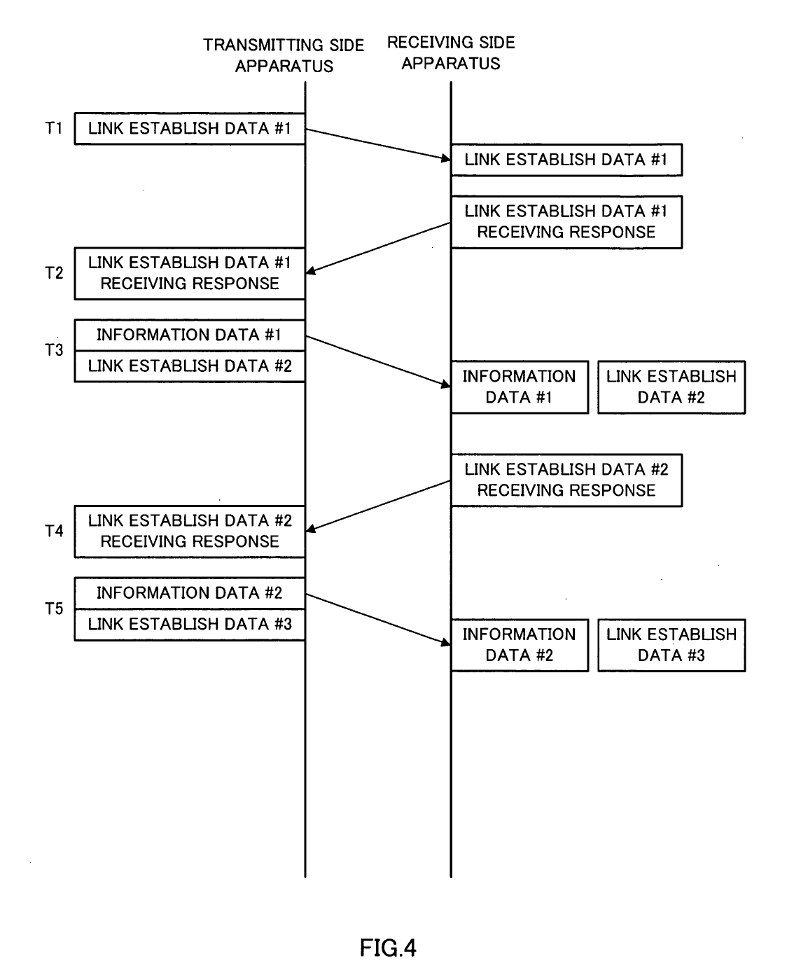

Next, the operation of the communication apparatus thus constructed is specifically described referring to the sequence chart of FIG. 4.

First, when transmitting a given amount of information data #1, the control section 130 controls the link establish data generating section 120 to generate link establish data #1 that requests the establishment of a link for the transmission of information data #1 and the transmitting section 100 sends the link establish data #1 at time T1. When the link establish data #1 is received at the receiving side apparatus, a link for the transmission of the information data #1 with the communication apparatus of this embodiment is established and the receiving side apparatus sends a link establish data #1 receiving response to notify the communication apparatus of the reception of the link establish data #1.

Then, at time T2, the receiving section 160 receives the link establish data #1 receiving response and the link establish data receiving response detecting section 150 detects the reception of the link establish data #1 receiving response. When the link establish data receiving response detecting section 150 detects the reception of the link establish data #1 receiving response, the control section 130 is notified of it. Then the control section 130 detects that a link for sending the information data #1 has been established and controls the information data generating section 110 to generate the information data #1. At the same time, the control section 130 controls the link establish data generating section 120 to generate link establish data #2 for requesting the establishment of a link for sending the next information data #2. Then the multiplexing section 200 multiplexes the information data #1 and the link establish data #2 and the transmitting section 100 sends the multiplexed data at time T3.

When the receiving side apparatus receives the information data #1 and link establish data #2 sent from the transmitting section 100, the receiving side apparatus separates the information data #1 and the link establish data #2, establishes a link for the information data #2, and sends a link establish data #2 receiving response to notify the communication apparatus of the reception of the link establish data #2. The receiving section 160 receives the link establish data #2 receiving response at time T4 and the link establish data receiving response detecting section 150 detects the reception of the link establish data #2 receiving response.

Now, since the link establish data #2 is sent being multiplexed with the preceding information data #1, no time is wasted before the reception of the link establish data #2 receiving response.

This reduces the ratio of the time required only for the link establishment with respect to the total transmission time, without reducing the number of times that a link establish request is generated, thus making it possible to save transmission time resources.

Referring to FIG. 4 again, when the link establish data #2 receiving response is received at time T4, the link establish data receiving response detecting section 150 detects the reception of the link establish data #2 receiving response. When the link establish data receiving response detecting section 150 detects the reception of the link establish data #2 receiving response, the control section 130 is notified of it. Then the control section 130 detects that a link for the information data #2 has been established and the multiplexing section 200 multiplexes the information data #2 and the link establish data #3, which is sent at time T5, as in the transmission of the information data #1.

Thus, according to this embodiment, the current information data and the link establish data for the next information data are sent together in multiplexed form, which further enhances the average transmission rate without reducing the number of link establish operations and hence without deteriorating the accuracy of information communication.

In the embodiments above, the send/receive of link establish data and the send/receive of information data, information data receiving response, and link establish data receiving response may be performed by full duplex communication. Then, even when the send/receive of link establishment overlaps in time with the send/receive of other signals, they can be sent/received using separate transmission paths, which further speeds up the link establishment requesting.

Also, in the embodiments above, the send/receive of link establish data and the send/receive of information data, information data receiving response, and link establish data receiving response may be performed by bi-directional simultaneous transmission using divisional multiple access such as the CDM (Code Division Multiple) system. In this case, too, even when link establish send/receive overlaps in time with that of other signals, they can be sent/received separately, so as to further speed up the link establishment requesting.

As described above, the present invention enhances the average transmission rate while preventing deterioration of the accuracy of information communication.

This application is based on Japanese Patent Application No. 2002-300726, filed on Oct. 15, 2002. The discussion therein is fully incorporated into the present application.

### INDUSTRIAL APPLICABILITY

The present invention is applicable to a communication apparatus and communication method.

1. A communication apparatus for use in a communication system that requires establishment of a link to transmit information between a transmitting side and a receiving side, comprising:
a transmitting section that transmits information data that contains a predetermined amount of information; and
a requesting section that, before termination of a link for information data transmitted currently, requests the establishment of a link for transmitting next information data.

2. The communication apparatus according to claim 1, wherein said requesting section comprises:
a link establish data generating section that generates link establish data for requesting the establishment of a link;
a control section that controls said link establish data generating section to generate the link establish data for establishing a link for the transmission of information data to be sent next; and
a transmitter section that transmits the generated link establish data immediately after said transmitting section transmits the information data.

3. The communication apparatus according to claim 1, wherein said requesting section comprises:
a link establish data generating section that generates link establish data for requesting the establishment of a link;
a control section that controls said link establish data generating section to generate the link establish data for establishing a link for the transmission of information data to be sent next;
a multiplexing section that multiplexes the generated link establish data and the information data to be transmitted currently by said transmitting section; and
a transmitter section that transmits the multiplexed information data and link establish data.

4. The communication apparatus according to claim 3, wherein said multiplexing section multiplexes the link establish data and the information data by using at least one of frequency division multiplexing, time division multiplexing, and code division multiplexing.

5. The communication apparatus according to claim 1, wherein said requesting section requests the establishment of a link by full duplex communication which simultaneously performs transmission and reception.

6. The communication apparatus according to claim 1, wherein said requesting section requests the establishment of a link by bi-directional simultaneous transmission using divisional multiple access.

7. A communication method for use in a communication system that requires establishment of a link to transmit information between a transmitting side and a receiving side, comprising the steps of:
transmitting information data that contains a predetermined amount of information; and
before termination of a link for the transmitted information data, requesting establishment of a link for transmitting next information data.
